(19) United States
(12) Patent Application Publication
(10) Pub. No.: US 2017/0188531 A1
(43) Pub. Date: Jul. 6, 2017

(54) ACCELERATED PLANT GROWTH SYSTEM

(71) Applicant: John J. Daniels, Madison, CT (US)

(72) Inventor: John J. Daniels, Madison, CT (US)

(21) Appl. No.: 15/062,132

(22) Filed: Mar. 6, 2016

Related U.S. Application Data
(60) Provisional application No. 62/128,722, filed on Mar. 5, 2015.

(51) Int. Cl. A01G 31/02; A01G 7/04

(52) U.S. Cl. CPC A01G 31/02; A01G 7/045; A01K 63/00

(57) ABSTRACT

Accelerated Plant Growth system includes a grow area provided for growing a plurality of plants. A lighting system generates at least one light spectrum received by the at least one plant. A beneficial microbe system provides beneficial microbes to the at least one plant. An input injecting system injects inputs for adjusting or modifying growing conditions of the plants. A solution reservoir and transport system holds and transports a growth solution to the plants in the grow area. A microclimate detecting system detects at least one parameter of a microclimate surrounding the at least one plant. A microprocessor receives the output of the microclimate detecting system and controls at least one of the lighting system, the beneficial microbe system and the solution reservoir and transport system in response to the received output from the microclimate detecting system to adjust or modify the growing conditions of the at least one plant.

### CROSS REFERENCE TO RELATED APPLICATIONS

This application is a US Utility Application of U.S. Provisional Patent Application Ser. No. 62/128,722, filed Mar. 5, 2015, which is incorporated by reference herein in its entirety.

### BACKGROUND OF THE INVENTION

The present invention relates to a system for growing plants indoors. More particularly, the present invention relates to a system that combines aspects of hydroponics, plant nutrients and artificial lighting in a unique method and self-contained apparatus that enables controlled inputs to modify or adjust sensed plant growth conditions.

### Hydroponics:

Hydroponics is a subset of hydroculture and is a method of growing plants using mineral nutrient solutions, in water, without soil. Terrestrial plants may be grown with their roots in the mineral nutrient solution only or in an inert medium, such as perlite or gravel. The two main types of hydroponics are solution culture and medium culture. Solution culture does not use a solid medium for the roots, just the nutrient solution. The three main types of solution cultures are static solution culture, continuous-flow solution culture and aeroponics. The medium culture method has a solid medium for the roots and is named for the type of medium, e.g., sand culture, gravel culture, or rockwool culture. There are two main variations for each medium, sub-irrigation and top irrigation. (see, for example wikipedia.org/wiki/Hydroponics)

### Plant Nutrients:

Plant nutrients used, for example, in hydroponics are dissolved in the water and are mostly in inorganic and ionic form. Primary among the dissolved cations (positively charged ions) are Ca2+ (calcium), Mg2+, (magnesium), and K+ (potassium); the major nutrient anions in nutrient solutions are NO 3 (nitrate), SO2-4 (sulfate), and H2PO-4 (dihydrogen phosphate). Numerous ‘recipes’ for hydroponic solutions are available. Many use different combinations of chemicals to reach similar total final compositions. Commonly used chemicals for the macronutrients include potassium nitrate, calcium nitrate, potassium phosphate, and magnesium sulfate. Various micronutrients are typically added to hydroponic solutions to supply essential elements. For example, Fe (iron), Mn (manganese), Cu (copper), Zn (zinc), B (boron), Cl (chlorine), and Ni (nickel) are all commonly added inorganic materials that can be included with organic based nutrients. Chelating agents are sometimes used to keep Fe soluble, and humic acids can be added to increase nutrient uptake by the plants. Plants will change the composition of the nutrient solutions upon contact by depleting specific nutrients more rapidly than others, removing water from the solution, and altering the pH by excretion of either acidity or alkalinity. It is also important not to allow salt concentrations to become too high, nutrients to become too depleted, or pH to change far from a desired value. (see, for example wikipedia.org/wiki/Hydroponics)

### Artificial Lighting:

Conventionally, when growing plants indoors artificial light is used to replicate natural light from the sun. If a plant does not get enough light, it will not grow well, regardless of other conditions. However, different plants and even the growth stages of the same plant, require different spectrum, intensity and duration of light to grow well. For example, vegetables grow best in full sunlight, and to flourish indoors it has been assumed that they need equally high light levels, whereas foliage plants (e.g., Philodendron) grow in full shade and can grow normally with much lower light levels. Also, it has been assumed that most plants require both dark and light periods, an effect known as photoperiodism, to trigger flowering. When growing plants under artificial lighting, it is well know that to trigger the effects of photoperiodism, the lights can be turned on or off at set times. The optimum photo/dark period ratio depends on the species and variety of plant. There has been an emphasis on the photoperiod when discussing plant development, some researchers suggest that it is the number of hours of darkness that affects a plant's response to day length. The typical wavelength range from 400 to 700 nm is knows as the photosynthetically active radiation (PAR). A range of bulb types can be used as grow lights, such as incandescents, fluorescent lights, high-intensity discharge lamps, and LEDs. Conventionally, the most often used lights for commercial growing operations include HIDs and fluorescents, but recent advances in power efficiency and optimized light spectra has resulting in attempts to use high-powered LED systems. Indoor flower and vegetable growers typically use high-pressure sodium (HPS/SON) and metal halide (MH) HID lights, but in some cases fluorescents and LEDs are replacing metal halides due to their efficiency and economy. Metal halide lights are regularly used for the first (or vegetative) phase of growth, as they emit larger amounts of blue and ultraviolet radiation. There is research that suggests that blue spectrum light may trigger a greater vegetative response in plants. High-pressure sodium lights are also used as a single source of light throughout the vegetative and reproductive stages. There is also research that suggests red spectrum light may trigger a greater flowering response in plants. Research has also shown that high-pressure sodium lights that are used for the vegetative phase, plants grow slightly more quickly, but will have longer internodes, and may be longer overall. According to some manufacturers of grow lights, plants require light levels between 100 and 800 μmol m-2 s-1.[17] For daylight-spectrum (5800 K) lamps, this would be equivalent to 5800 to 46,000 lm/m2. See, for example, wikipedia.org/wiki/Grow light).

Although there have been prior attempts to grow plants indoors using hydroponic, plant nutrient and artificial lighting techniques, there is a need for a system that combines aspects of hydroponics, plant nutrients and artificial lighting in a unique method and self-contained apparatus that enables sensing plant growth conditions and automatically controlling the injection of inputs to modify or adjust the sensed plant growth conditions.

### SUMMARY OF THE INVENTION

The present invention is intended to overcome the drawbacks of the prior attempts and provides a system that combines aspects of hydroponics, plant nutrients and artificial lighting in a unique method and self-contained apparatus that enables sensing plant growth conditions and automatically controlling the injection of inputs to modify or adjust the sensed plant growth conditions.

In accordance the inventive Accelerated Plant Growth system, a grow area is provided for growing a plurality of plants. A lighting system generates at least one light spectrum received by the at least one plant. A beneficial microbe system provides beneficial microbes to the at least one plant. An input injecting system injects inputs for adjusting or modifying growing conditions of the plants. A solution reservoir and transport system holds and transports a growth solution to the plants in the grow area. A microclimate detecting system detects at least one parameter of a microclimate surrounding the at least one plant. A microprocessor receives the output of the microclimate detecting system and controls at least one of the lighting system, the beneficial microbe system, the input injecting system, and the solution reservoir and transport system in response to the received output from the microclimate detecting system to adjust or modify the growing conditions of the at least one plant.

In accordance with another aspect of the invention, at least one grow condition is measured of a microclimate surrounding a growing plant. At least one of a lighting spectrum, lighting intensity, air temperature, soil temperature, beneficial microbe, soil chemistry, air moisture, soil moisture, air chemistry, air particulate, and soil particulate is adjusted dependent on the measured aspect.

In accordance with another aspect of the invention at least one aspect of a remote microclimate is measured. The measurement is transmitted to a microprocessor over a network connection. At least one aspect of a local microclimate surrounding a growing plant is controlled to replicate at the local microclimate the measured aspect of the remote microclimate.

### BRIEF DESCRIPTION OF THE DRAWINGS

FIG. 1 illustrates a non-limiting, exemplary embodiment of the inventive Accelerated Plant Growth System;

FIG. 2 is a perspective view of the the inventive Accelerated Plant Growth System;

FIG. 3 is a side view of the inventive Accelerated Plant Growth System;

FIG. 4 is a perspective view of the inventive Accelerated Plant Growth System showing lowered telescoping supports and lighting system;

FIG. 5 is an enlarged front view of the inventive Accelerated Plant Growth System;

FIG. 6 is an isolated view of a reflective lighting panel;

FIG. 7 is a perspective view showing a commercial growing arrangement of the modular table sections;

FIG. 8 is a top plan view illustrating a flexible printed circuit LED lighting element;

FIG. 9 is a top plan view illustrating another configuration of the LED lighting element;

FIG. 10 is a table showing the characteristics of a exemplary LED packaged lamp;

FIG. 11 is a table showing the characteristics of a exemplary LED packaged lamp;

FIG. 12 is a top plan view illustrating another configuration of the LED lighting element;

FIG. 13 is a photo showing an embodiment of an exemplary LED lighting element;

FIG. 14 is an illustration showing an aquaponic system in accordance with the inventive Accelerated Plant Growth System;

FIG. 15 is a perspective view of an embodiment of an LED lighting rack;

FIG. 16 is a side view showing an assembly of LED lighting racks;

FIG. 17 is a perspective view of the assembly of LED lighting racks;

FIG. 18 is a block diagram showing an inventive electronic monitoring and metering system;

FIG. 19 schematically shows a real time replicated growing conditions utilization of the inventive Accelerated Plant Growth System;

FIG. 20 is a perspective view showing a configuration of the inventive Accelerated Plant Growth System showing three separate growing spaces;

FIG. 21 is a bottom perspective view showing the configuration show in FIG. 20 showing individually controllable LED lighting systems associated with each separate growing spaces; and

FIG. 22 illustrates a system for collecting growth condition data over a network connection (e.g., WAN and Internet).

### DETAILED DESCRIPTION OF THE INVENTION

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

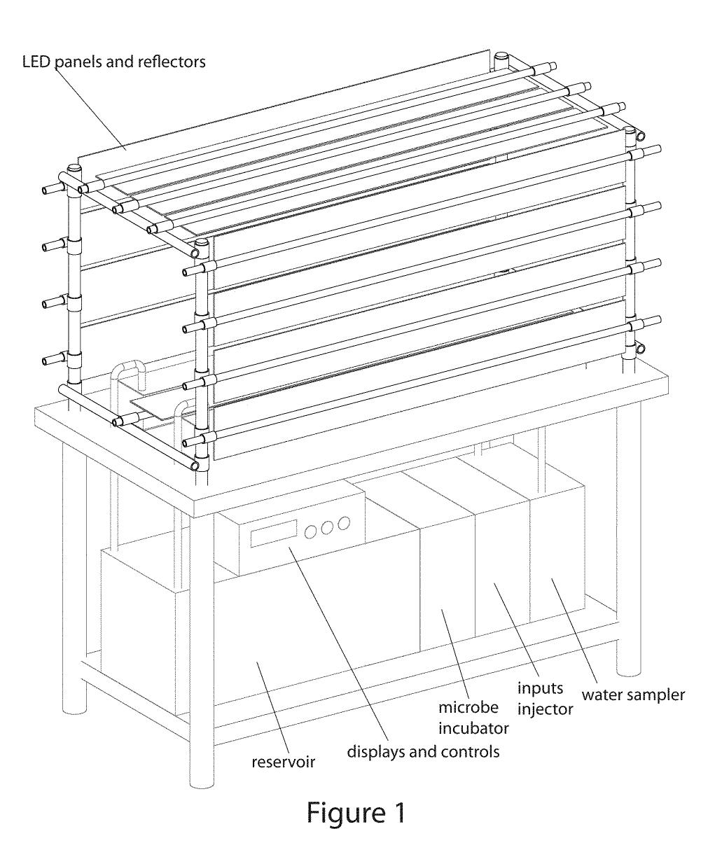

FIG. 1 illustrates a non-limiting, exemplary embodiment of the inventive Accelerated Plant Growth System. This embodiment can be constructed, for example using stainless steel materials and create a self-contained grow unit, designed specifically to utilize beneficial microbes. Water sampling and auto-addition of nutrients and other inputs makes growing plants faster and easier. A grow area is provided for growing a plurality of plants. The grow area is radiated with light energy from a lighting system. The lighting system generates at least one light spectrum received by the plants. The light spectrum may controlled to radiate light that is specific for the type of plant being grown, and may be varied depending on the type of plant and growth cycle of the plant. For example, the lighting system may comprise LED panels and reflectors that are removably disposed on a support structure. The lighting system may include a combination of lighting sources, each lighting source being separately controlled depending on one or more sensed growth condition and/or determined by a growth schedule.

A solution reservoir and transport system is provided for holding and transporting a growth solution to the plants in the grow area. For example, the growth solution may be plain water or water having dissolved and/or suspended nutrients, minerals, fertilizer and/or beneficial microbes. A pump within the reservoir forces the solution through piping and into growing trays disposed within the grow area. The growing trays hold the plants being grown. A return drain system includes piping that returns the solution to the reservoir via other components that sense the characteristics of the solution, and as necessary, injects inputs into the solution to enhance the growing of the plants.

The microclimate detecting system detects at least one parameter of a microclimate surrounding the at least one plant. The at least one parameter is a growth condition that may vary over time during the growing of the plant. For example, the growing condition may be at least one of ambient air temperature; soil temperature; air chemistry; soil chemistry; growth medium temperature; growth; medium chemistry; growth medium color; plant height; plant color; plant growth rate; beneficial microbes; harmful microbes; beneficial flora and fauna; harmful flora and fauna; and the like. The microclimate detecting system includes sensors or detectors that determine each detected growing condition. Each growing condition may be detected by a separate sensor or detector, for example, soil pH may be detected by a dedicated pH detector. Alternatively or additionally, a sensor or detector may detect two or more growth conditions. For example, a chemistry detector may detect the presence and quantity of dissolved oxygen, salts and other chemicals held and transported in the solution reservoir and transport system.

For example, a water or solution sampler senses the chemistry of the solution and provides the sensed information to a computer (microprocessor, etc.) that is housed within a displays and controls box.

The microprocessor receives the output of the microclimate detecting system and controls at least one of the lighting system, the beneficial microbe system and the solution reservoir and transport system in response to the received output from the microclimate detecting system. An input injecting system injects inputs for adjusting or modifying growing conditions of the plants. For example, an inputs injector may include different fertilizers and nutrients and under the control of the microprocessor, injects a determined input into the solution that flows into and is held in the reservoir.

A beneficial microbe system provides at least one beneficial microbe as an input to the growth conditions. The beneficial microbe system may include a microbe-supporting lighting system for generating a micro-supporting light spectrum specific for the microbes. As an example, a microbe incubator can be provided for supporting the growth of beneficial microbes that are conveyed to the input injecting system, for example, via tubing and a valve and pump controlled by the microprocessor. The beneficial microbes can be injected into the the solution that flows into, out of, and/or is held in the reservoir. The beneficial microbe system can include an incubator that grows the microbes under preferred conditions to ensure that a healthy colony of beneficial microbes are available for aiding in the growth of the plants in the grow area.

There is a symbiotic relationship between plants and some microbes. The plants provide a host while these naturally occurring microorganisms, otherwise known as beneficial microbes, enhance the growth of plants. For example, some macrobiotic organisms inhabit the root zone and vascular system of a plant, assisting in the breaking down, retention and transportation of nutrients and water. There are photosynthetic strains of bacteria and other microbes that are capable of converting radiant energy, including sunlight and spectrum produced by artificial lighting, into chemical energy that can be used to enhance plant growth, or relieve the plant from supporting the microbe in the symbiotic relationship. Other micro organisms are effective at breaking chemical bonds, helping the plant with nutrient uptake that otherwise may not be available.

Although often naturally occurring in soil, especially under artificial growing conditions the beneficial microorganisms can easily become depleted. In the case of a soilless growing conditions, the beneficial microorganisms may not exist in the grow system. In accordance with an aspect of the inventive Accelerated Plant Growth System, a microbe incubator supports the growth of beneficial microbes that can then be injected as an input, ensuring that a healthy colony of beneficial microbes are available for aiding in the growth of the plants in the grow area.

The beneficial microbe system may include a microbe-supporting lighting system for generating a microbe-supporting light spectrum specific for the microbes. In addition to providing controlled spectrum and intensity wavelengths to the growing plants, the inventive LED lighting system shown in the Figures and described herein can be particularly effective for providing light spectrum that is suited for the photosynthetic beneficial microbes. The beneficial microbe system may include a microbe incubator and the microbe-supporting lighting system is disposed in the incubator for radiating microbes growing in a liquid contained the microbe incubator. The beneficial microbes may be obtained from a commercially available product, such as Quantum Growth (see, growquantum.com).

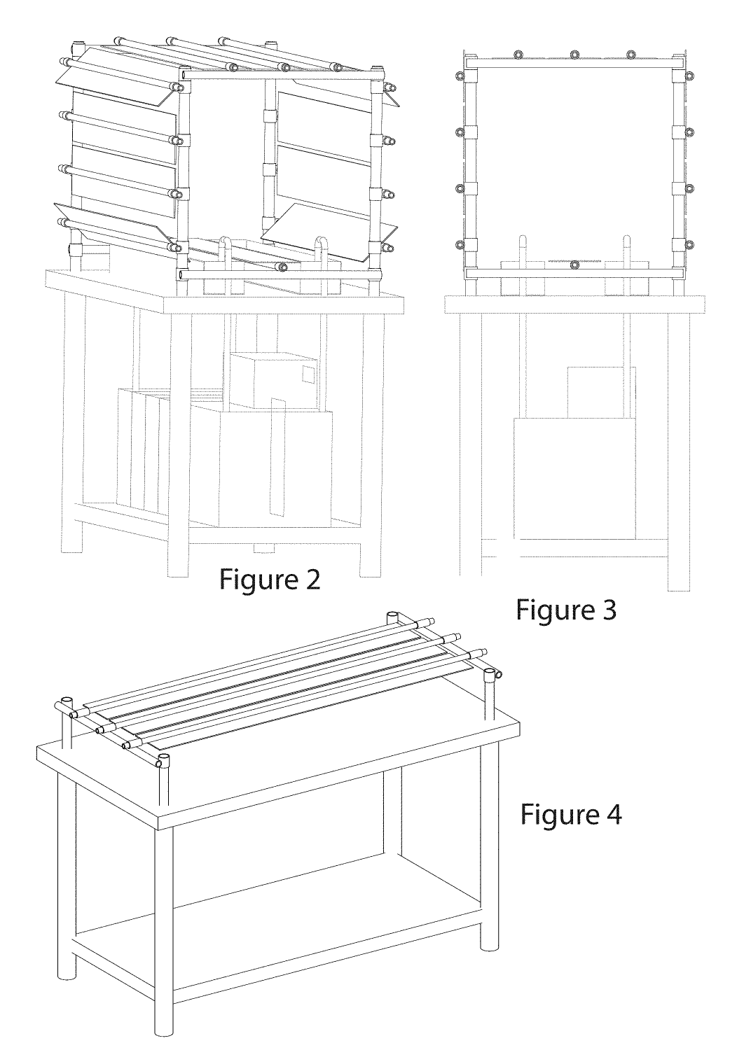

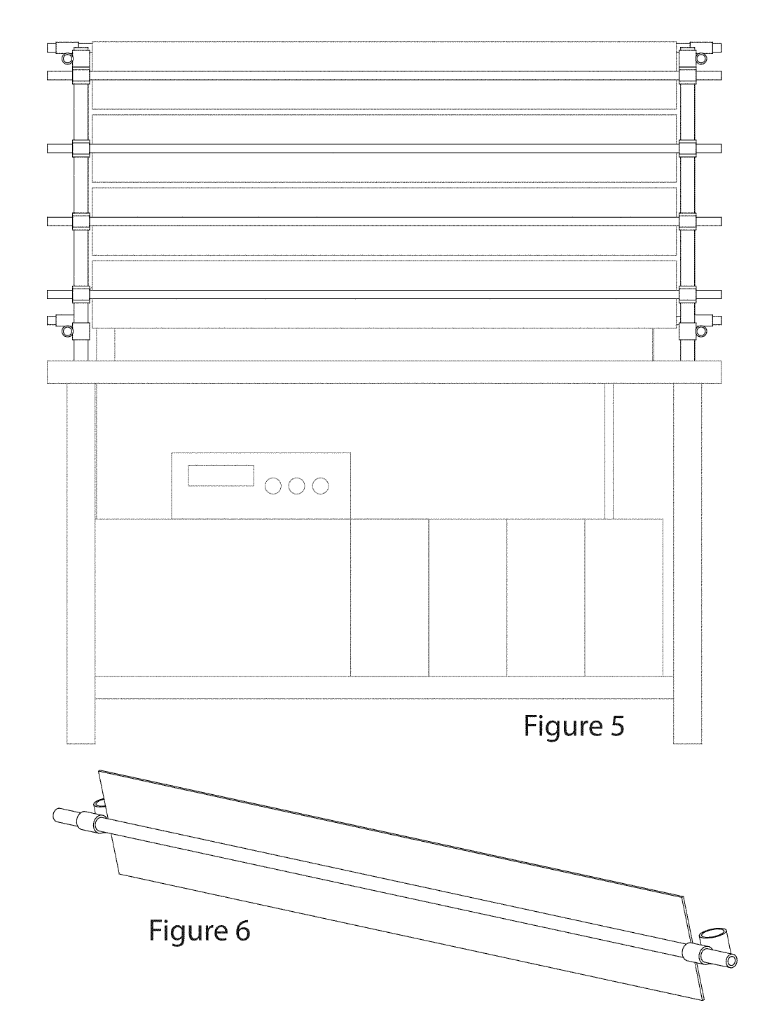

FIG. 2 is a perspective view of the the inventive Accelerated Plant Growth System. As shown, the lighting system may include LED panels and reflectors that are separately adjustable to angle the light spectrum emitted by the LEDs towards the plants grown in the grow area. The LED panels are mounted on a support structure that includes telescoping posts (see, for example, FIG. 4) to easily raise and lower the height of horizontal lighting sources (LED, or conventional high intensity, florescent tubes, etc.). The LED panels can be provided as the primary light source, or, as an additional light source used with a more intense conventional light source (such as HID). This hybrid lighting configuration provides the intensity of the HID for blooming, flowing, bud production and fruiting prior to harvest combined with the advantages of the solid state LED lighting with controlled spectrum and intensity. By providing the LED panels and reflectors at various locations and angles relative to the plants, the light spectrum can more easily infiltrate the growing plant canopy as compared with the conventional technique of blasting relatively high emissions of light spectrum from the top down through the canopy. By providing the controlled spectrum, intensity and duration radiating in at the growing plants from a number of different angles, relatively lower intensity light can be used since more of the available light photons will be received by the plant structures and the beneficial microbes that absorb and make use of the photons for photosynthesis and other plant functions. Also, a fan (not shown) can be provided to blow air over the growing plants to help strengthen the plants and circulate the air.

FIG. 3 is a side view of the inventive Accelerated Plant Growth System. The panels can be angled to maximize the penetration as the plan canopy grows. Some panels could be plain retroreflectors The posts supporting the LED panels telescope into the grow table legs, allowing the height and number of the panels relative to the growing plants to be adjustable during the growth cycle.

As shown, the grow area includes plant trays that hold the growing plants. The inventive system can be used with many growing methods including soil and soilless techniques. Since the light from the light sources is able to penetrate through to the plant structures (e.g., leaves) from many angles, the shape of the plant can also be controlled through heliotropism (the directional growth of a plant towards light). Also, the controlled spectrum available using LED lighting can further be used to shape the growing plant. For example, to force a plant to grow relatively short and bushy, the light sources from the sides and below the plant can be used to radiate light spectrum that promotes short plants. On the other hand, to force a plant to grow relatively tall and thin, light sources from the top of the plant can be used to radiate light spectrum that promotes tall plants. This feature enables the grower to determine the shape of the plant based on the light radiation angles relative to the growing plant, as well as the controlled duration, intensity and wavelength of the light spectrum. Other factors, such as nutrients, water quantity and times, microbes, etc. can also be controlled depending on the desired plant growth characteristics. As an example, roses can be grown so that the peak bloom of the rose flower is timed to the Valentine's Day holiday. Other plants, such as lettuce, can be grown so thats the peak harvest period is timed to a desired date to enable a grower to have on hand a constant supply of fresh lettuce at its peak size and flavor for sale.

FIG. 4 is a perspective view of the inventive Accelerated Plant Growth System showing lowered telescoping supports and lighting system. The lighting system includes posts and beams, which can be made from a variety of materials, such as wood, stainless steel, aluminum, plastic, etc. As depicted, the posts and beams are easily connected to each other to form a support for separate LED panels and reflectors that can be attached to the the support structure as needed. FIG. 4 shows the posts telescoping into the legs of the grow table to easily adjust the height of horizontally disposed LED panels and reflectors at a desired distance from the grow area (and thereby adjust the distance from the top of the growing plants to the lighting source). The support structure for the lighting can also be configured to enable the light sources to easily swing open and allow easy access to the growing plants. Also, larger sized reflective panels (not shown) can be provided to further recycle the light emitted from the light sources

FIG. 6 is an isolated view of a reflective lighting panel. The reflector is fixed to a support structure that includes engagement members that slide on the posts of the lighting support posts. A clamping mechanism can be provided to set the reflected lighting panel at a desired position on the two posts that support it, and the reflector and lighting source can be pivotally mounted to the support structure so that the angle of the light radiated and reflected can be adjusted relative to the growing plants.

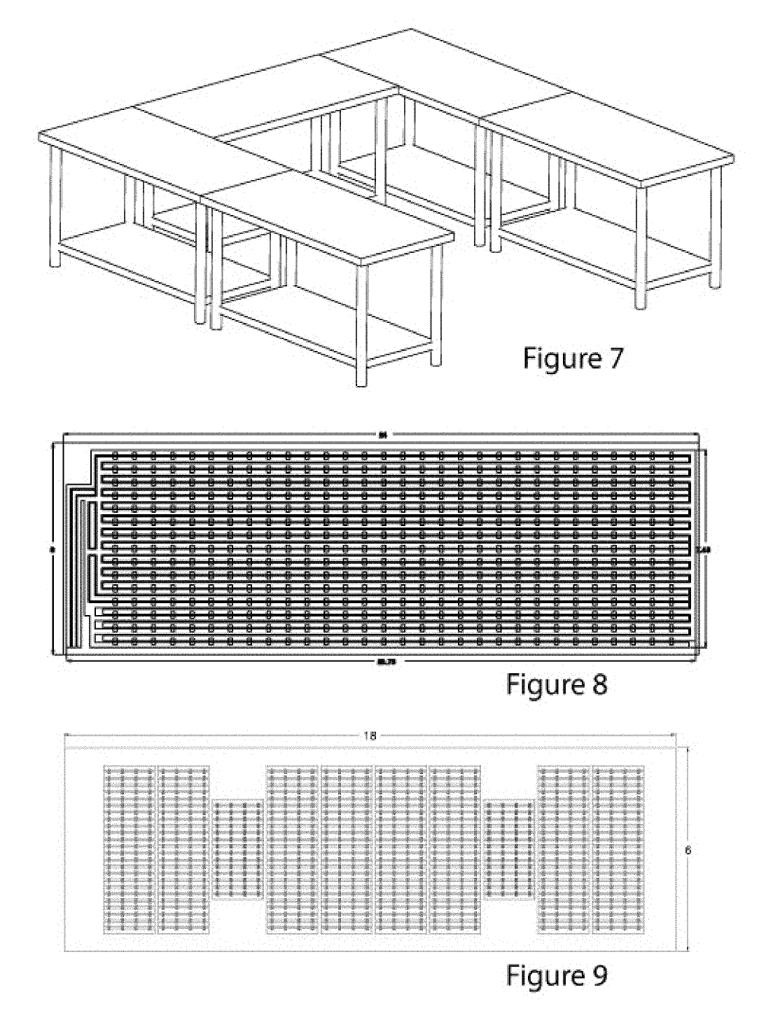

FIG. 7 is a perspective view showing a commercial growing arrangement of the modular table sections. For clarity, only the tables are shown, however, each table can be configured along the lines of the Accelerated Plant Growth System described herein. The commercial growing arrangement enables a modular approach that can be expanded, contracted and/or configured to fit the needs of a commercial growers. Components, such as water sources/reservoirs, input injectors, sensors, microcontrollers, computers, network resources, etc., can be shared among the modules to reduce redundancy and costs. The input injectors (input injecting system) may be, for example, pumps and tubing that transport fluid concentrates of, for example, fertilizer, nutrients, minerals, microbes, etc., from bottles and injects the concentrates into the the water or growth medium held in the reservoir or upstream from the reservoir and into the piping carrying the contents of the reservoir to the plants. Gasses, such as CO2 can be injected into the ambient air, and heat can also be added or removed from the grow area through use of heaters, fans, or, by heating or cooling the water or liquid growth medium that is provided to the growing plants.

In accordance with the inventive Accelerated Plant Growth System controls are provided to enable a grower to adjust the inputs (light, water, nutrients, microbes, CO2, heat, etc.) based on sensed information obtained from the soil and ambient conditions of the growing plants. Over time, using this system, a grower will produced selectively culled plants that have characteristics that the grower desires (growth cycle, active chemical composition that affects things like taste, shelf life, time to ripen, etc., size of plant and buds, etc., etc.).

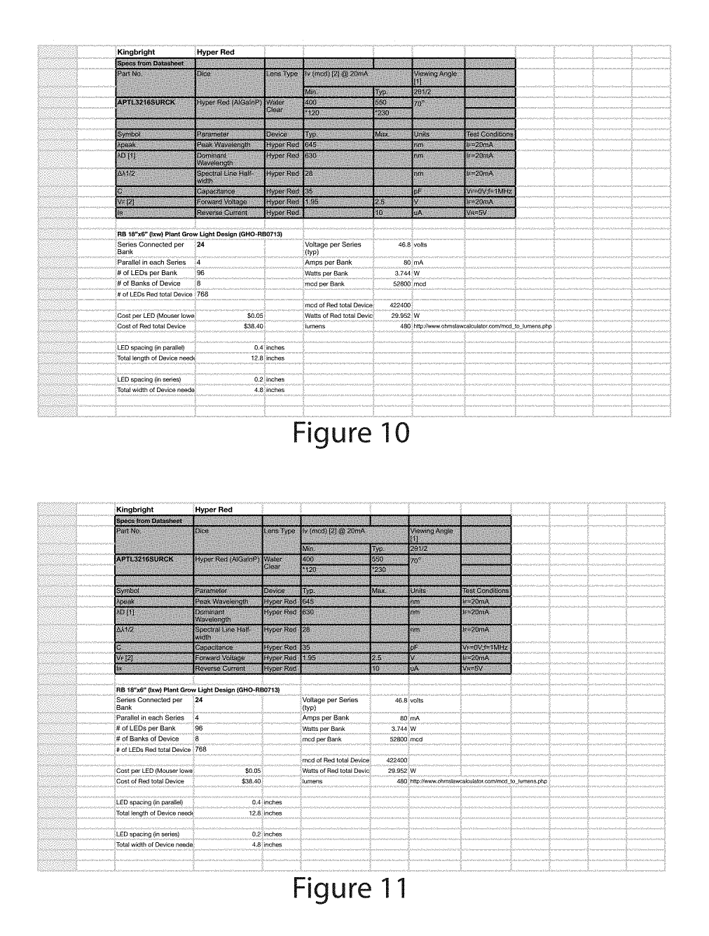

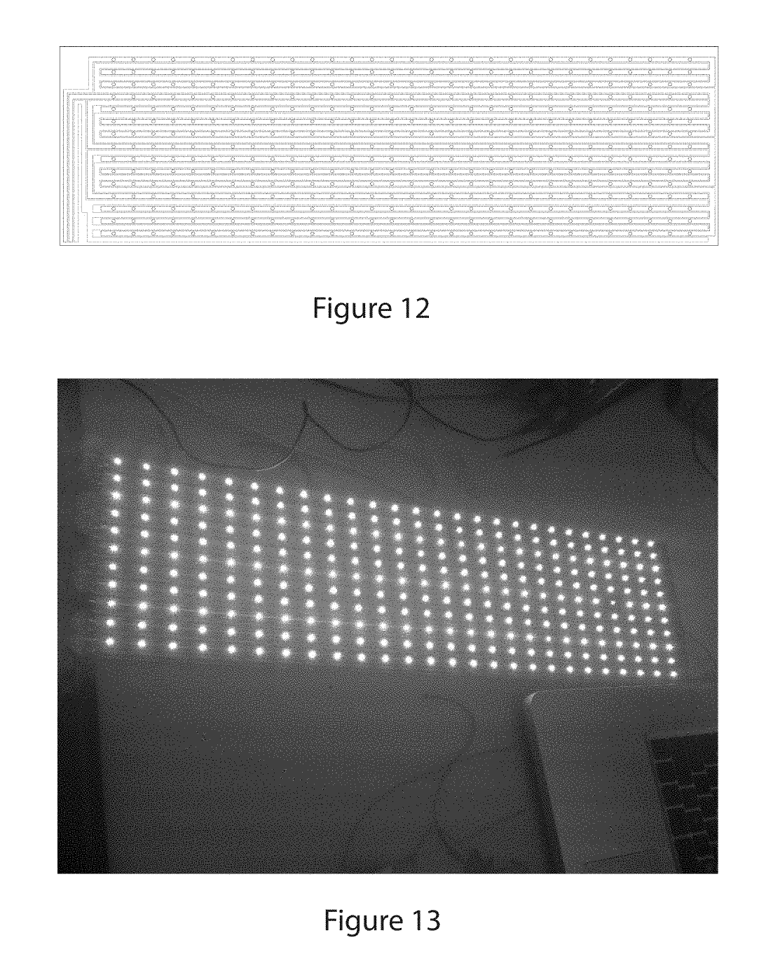

FIG. 8 is a top plan view illustrating a flexible printed circuit LED lighting element. FIG. 9 is a top plan view illustrating another configuration of the LED lighting element. FIG. 10 is a table showing the characteristics of a exemplary LED packaged lamp. FIG. 11 is a table showing the characteristics of a exemplary LED packaged lamp. FIG. 12 is a top plan view of illustrating another configuration of the LED lighting element. FIG. 13 is a photo showing an embodiment of an exemplary LED lighting element.

The inventive Accelerated Plant Growth System can be configured to use a hybrid lighting system. The LED lighting system is used, for example, during the vegetative growth stage, and higher intensity light sources, such as HID are used during flowering and budding. The inputs such as lighting intensity and wavelength, ph, nutrients, CO2, temperature, moisture and humidity, etc., are sensed and controlled. The inventive Accelerated Plant Growth System is modular and can be used as a multistage single system to have a constant production of buds or fruit, or in a commercial growing environment used to optimize the conditions for each stage of growth from seeds to bud/fruit.

Although for many applications LEDs are still too expensive and not powerful enough to be used cost effectively solely to get the plants to flower and produce buds, the hybrid lighting approach of the present invention uses LED lighting in combination with at least one of Ceramic metal halide (CDM), Metal halide (MH), Combination metal halide (MH) and HPS “Dual Arc”, Fluorescent, Incandescent lighting. This approach uses the best of LED and traditional, low efficiency HID and/or low pressure sodium lighting. For example, traditional lighting can be primarily used to promote flowing and bud generation. The LED lighting can be used primarily during germination, pre-flower, cloning and to maintain mother and/or father plants for clone production.

The use of LEDs for growing indoor crops has a lot of appeal. LEDs have the potential to be more energy efficient, with a much longer service life, and have the ability to selectively apply a narrow spectrum or multiple spectrums (wavelengths) depending on the LED emitters provided in the LED lighting source. However, relatively few indoor growers employ LED lighting primarily because of the high upfront cost per lumen output.

The microprocessor can automatically control the light spectrum generated by the lighting system depending on at least one of the type of plant and growth cycle of the plant. For example, during the vegetative growth phase of some plants, it may be beneficial to irradiate the plant with continuous low dosage red spectrum lighting 24 hours a day, and add additional blue spectrum, red and orange spectrum for other durations during the day. For example, in accordance with the inventive Accelerated Plant Grow System, LED lighting is strategically utilized to provide the proper wavelength, intensity and duration for a portion of the plant growth cycle such as during the seedling and vegetive growth stages, and also used to supplement conventional higher intensity lighting. By providing the LED light at angles other than the conventional top down lighting approach, the relatively lower intensity LED light is received by the light receptive parts of the growing plant (and photosynthetic microbes) without requiring the very high intensity, energy inefficient, and costly lighting usually associated with indoor growing.

Also research has shown the potential benefits of using a 24 hour photoperiod for the production of greenhouse crops, transplant production in closed controlled environment systems and the culture of plants in controlled ecological life support systems. Continuous lighting has been shown to be a useful tool for speeding up the selection of crops. A plant's response to continuous light depends on plant tolerance and can be modified by alterations in temperature, light intensity, CO₂ level, humidity, mineral nutrition and other environmental factors. (see, for example, Plants under Continuous Light: A Review; Marina I. Sysoeva, Eugenia F. Markovskaya, Tatjana G. Shibaeva; Institute of Biology, Karelian Research Centre, Russian Academy of Science, 11, Pushkinskaya st., 185910 Petrozavodsk, Russia).

The LED lighting system described here is particularly suited to providing energy efficient, relatively lower intensity lighting with controlled spectrum during long duration or continuous lighting applications.

As an example of a controlled output, an LED lighting system can be controlled to provide a wavelength, intensity and duration cycle that is suitable for an intended grow pattern and/or portion of a growth cycle of a plant. The lighting system generates at least one light spectrum received by the at least one plant. The light spectrum may be specific for the plant to be grown. The light spectrum may be variable depending on the type of plant and growth cycle of the plant.

As an example, the LED lighting system stimulates plant growth by emitting an electromagnetic spectrum appropriate for photosynthesis. The LED lighting system can be used in conjunction with naturally occurring light, in conjunction with other electric lighting sources (low pressure sodium, HID, florescent, etc.) and/or other applications of the inventive Accelerated Plant Growth System where supplemental light is required. For example, if plants do not receive enough light at the correct wavelength and intensity, the plant will grow long and spindly. By controlling the wavelength, intensity and duration of various LED light emitting elements, the shape and growth pattern of the plants can be controlled.

The LED lighting system can be used alone or in combination with other natural and/or electric light sources to provide a light spectrum similar to that of the sun, or to provide a spectrum that is more specific to the needs of the plants being cultivated and/or the desired plant growth. For example, a bushy shaped mother plant can be obtained if desired, by controlling the wavelength, intensity and duration provided by the lighting provided by the LED lighting system that irradiates the vegetative plant grow area (or an area specific to where the mother plants are grown. Also, outdoor lighting conditions can be replicated with varying color, temperatures and spectral outputs from the LED light system, and different lighting characteristics can be applied at the different grow spaces depending on the plant(s) located at the space and/or the plant grow cycle of the plant(s) located in the space. The combined characteristics, lumen output (intensity), spectrum, etc., produce by the natural and artificial lighting radiating the space can be controlled depending on the type of plant being cultivated, the stage of cultivation (e.g., the germination/vegetative phase or the flowering/fruiting phase), and the photoperiod required by the plants, specific ranges of spectrum, luminous efficacy and color temperature that are desirable for use with specific plants and time periods. The artificial lighting can be controlled, for example, depending on the sensed growth conditions besides the ambient lighting. For example, the sensed growth conditions can include at least one of ambient air temperature; soil temperature; air chemistry; soil chemistry; growth medium temperature; growth; medium chemistry; growth medium color; plant height; plant color; plant growth rate; beneficial microbes; harmful microbes; beneficial flora and fauna; harmful flora and fauna; and the like.

The inverse-square law determines that the intensity of light radiating from a point source (in this case an LED or other electric light bulb) that reaches a surface is inversely proportional to the square of the surface's distance from the source. That is, if an object is twice as far away, it receives only a quarter the light). Accordingly, the distance from the LED or electric light source to the plant can be controlled, and the photons generated from various angles relative to the plant (that is, not just top down through the plant canopy) can be directed by placing the LED lighting system (or other lighting system) at defined angles and distances relative to the growing plant. Also, reflective surfaces can be used to maximize light recycling and to help the plants to all receive equal lighting so that the light generated by the light sources primarily falls on the plants rather than on the surrounding area.

In accordance with the inventive Accelerated Plant Growth System, desired wavelengths necessary for photosynthesis and to stimulate particular plant growth can be radiated from the LED grow lights for both a first (or vegetative) phase and a second (or reproductive) phase of growth. NASA has tested LED grow lights for their high efficiency in growing food in space for extraterrestrial colonization. Findings showed that plants benefit from the use of red, green and blue parts of the visible light spectrum. Accordingly, these spectrum can be selectively applied via the LED lighting system and depending on the sensed growth conditions, predetermined timing, or under the manual control of the grower. The lighting system is controlled to apply specific quantities of light (measured in lumens) necessary, for example, to stimulate photosynthesis, plant growth, bud, flower and fruit production.

Since different stages of plant growth require different spectra, the grow spaces can be separately applied with different combinations of wavelength, intensity and duration depending on the plant stage, desired growth changes (bushy plant versus tall plant, leafy vegetables versus fruit production, etc.). As an example, studies have shown that the initial vegetative stage benefits from more of a blue spectrum of light, whereas the later “flowering” stage is typically advantaged by a red-orange spectra.

Although more costly per lumen output than other light sources, LEDs have advantages that are utilized in accordance with the inventive system. LEDs allow production of bright and long-lasting grow lights that emit only the wavelengths of light corresponding to the absorption peaks of a plant's typical photochemical processes. Compared to other types of grow lights, LEDs for indoor plants are attractive because they do not require ballasts and produce considerably less heat than incandescent lights. LEDs are usually run at around 45-60 degrees Celsius. Also, plants under LEDs transpire less as a result of the reduction in heat, and thus the time between watering cycles is longer. There are multiple absorption peaks for chlorophyll and carotenoids, and LED grow-lights may use one or more LED colors overlapping these peaks. Recent attempts at the design of correctly tuned LED modules optimize the blue and red energy produced by the LED to closely match the plant requirements for optimum growth. It is also often published that for vegetative growth, blue LEDs are preferred, where the light has a wavelength in the mid-400 nm (nanometer) range. For growing fruits or flowers, a greater proportion of red LEDs is considered preferable, with light very near 600-640 nm, the exact number this wavelength being more critical than for the blue LED. As an example, three wavelength, 470 nm, 612 nm and 660 nm, the 612 nm can be used with one targeting not photosynthesis but carotenoids. Recent experiments show that providing plants with white LED is also viable because LED colour is achieved by using multiple compounds; thus, it may be possible to provide all the wavelengths required with a white LED of the correct colour temperature. Chlorophyll absorption peaks are 430 nm and 662 nm for chlorophyll a, and 453 nm and 642 nm for chlorophyll b. Chlorophyll b is not as abundant as chlorophyll a, and merely help in increasing the absorption range. Since the inventive system creates essentially an automatically controlled and closed growing process, with multiple grow areas, these advantages and particulars of using LED lighting with controlled spectrum output can be applied and maximized as compared with conventional indoor growing methods, making LED lighting a cost effective component in the inventive system.

The LED lighting system can be mechanically or otherwise in communication with the trays that make up the grow spaces so that heat from the LEDs is thermally conducted to plants growing in the grow spaces. For example, by disposing the LED lighting system above the vegetative grow space, with the flowering/blooming grow space disposed above, as shown, the heat from the LED lighting system, which is considerably more efficient and thus the generated heat easier to manage, can be used to warm the shelf and thus warm the plants growing in the flowing grow space without generating excessive heat (as is almost always the case in conventional high intensity lighting systems). Thus, the heat generated by the LED lighting systems is used advantageously rather than being a problem. Baffles can be selectively applied so that the lighting characteristics radiated to the the grow spaces (or sub divisions within a grow space) can be selectively controlled.

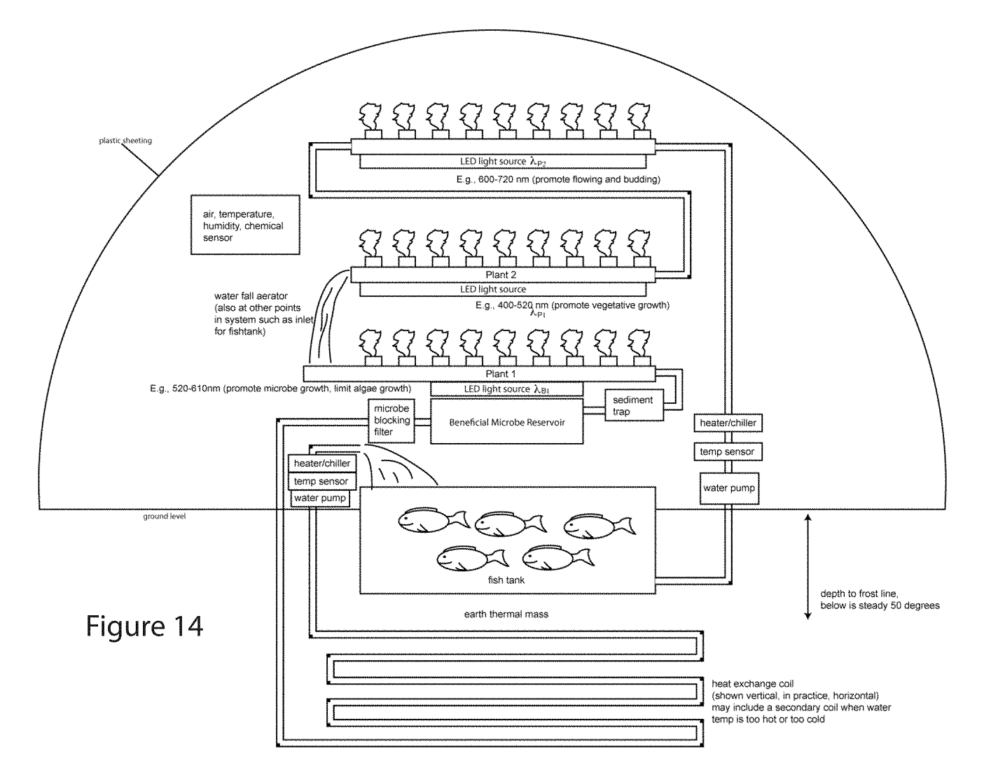

FIG. 14 is an illustration showing an aquaponic system in accordance with the inventive Accelerated Plant Growth System. Starting at the Beneficial Microbe Reservoir, at least one type of photosynthetic bacteria is grown to produce, among other things, nitrogen compounds that can be taken up by the plants. These nitrogen compounds are added to the water by the microbes.

A Microbe Blocking Filter may be provided to help retain microbes in the Beneficial Microbe Reservoir. The microbes may also be present throughout other locations in the system, including in the plant beds and fish tank, and within the plants themselves, etc.

The water flows from the Microbe Blocking Filter to a Heat Exchange Coil that can be buried below the frost line. The Heat Exchange Coil uses the earth as a thermal mass to cool the water when it is too hot or to heat it when it is too cold. Water flow, coil size, buried depth, etc., are pre-determined to optimize the system.

A Water Pump brings the water up from the Heat Exchange Coil and the water temperature is detected. The water may be heated or chilled as needed, and/or preferably, the water flow rate is adjusted so that the Earth Thermal Mass is used effectively to minimize the energy needed to heat or chill the water. (note: under preferred conditions, the heat is supplied from the LED lights as discussed herein and the Heat Exchange Coil and water flow rate are adequate for maintaining the proper water temperature without additional energy input.)

The water then flows through a waterfall aerator and into the Fish Tank. The fish in the Fish Tank excrete nitrogen compounds and other nutrients ultimately usable by the plants. The Fish Tank may be partially submerged in the ground for insulation and to act as a heat sink that absorbs the heat released from the Earth Thermal Mass (e.g., during night time).

The water flowing from the bottom of the Fish Tank now has nitrogen compounds and nutrients supplied by the Beneficial Microbes and the Fish. A second Water Pump is used to pump the water up to the upper most plant bed. Before reaching the plant bed, the water temperature is sensed and adjusted if needed.

The light source for the plants in the upper most bed may be sunlight (which may be supplemented by artificial light (not shown). Plant-useable nitrogen compounds and oxygenated, nutrient rich water is received in the upper most plant bed and flows over the plant roots. An LED light source is in thermal contact with the bottom of the upper most plant bed. Water flowing through the plant bed cools the LED light source. During cooler temperatures (i.e., winter and night time), this heat added to the water is a benefit to the system. During warmer daytime temperatures it is not likely that the LED light sources will be needed as much if at all, but if the water temperature gets too hot the excess heat is removed from the water when flowing through the Heat Exchange Coil. An auxiliary Heat Exchange Coil can be included in the system and brought online as needed through use of a diverter valve system (not shown).

The water flows through one or more additional plant bed levels, each with a similar configuration of LED light source for the plant bed below it. The wavelength and intensity of the LED light is selected according to the plant's growth cycle, type of plant, desired time to harvest, desired shape of the plant, and other photo-active determinable factors.

In accordance with this aspect of the invention, a microclimate detecting system can also be included that detects at least one of ambient air temperature; soil temperature; air chemistry; soil chemistry; growth medium temperature; growth; medium chemistry; growth medium color; plant height; plant color; plant growth rate; beneficial microbes; harmful microbes; beneficial flora and/or fauna; and harmful flora and/or fauna. Inputs added to the relatively closed environment of the aquaponics system can be automatically controlled to adjust or modify the growing conditions based on the detected conditions.

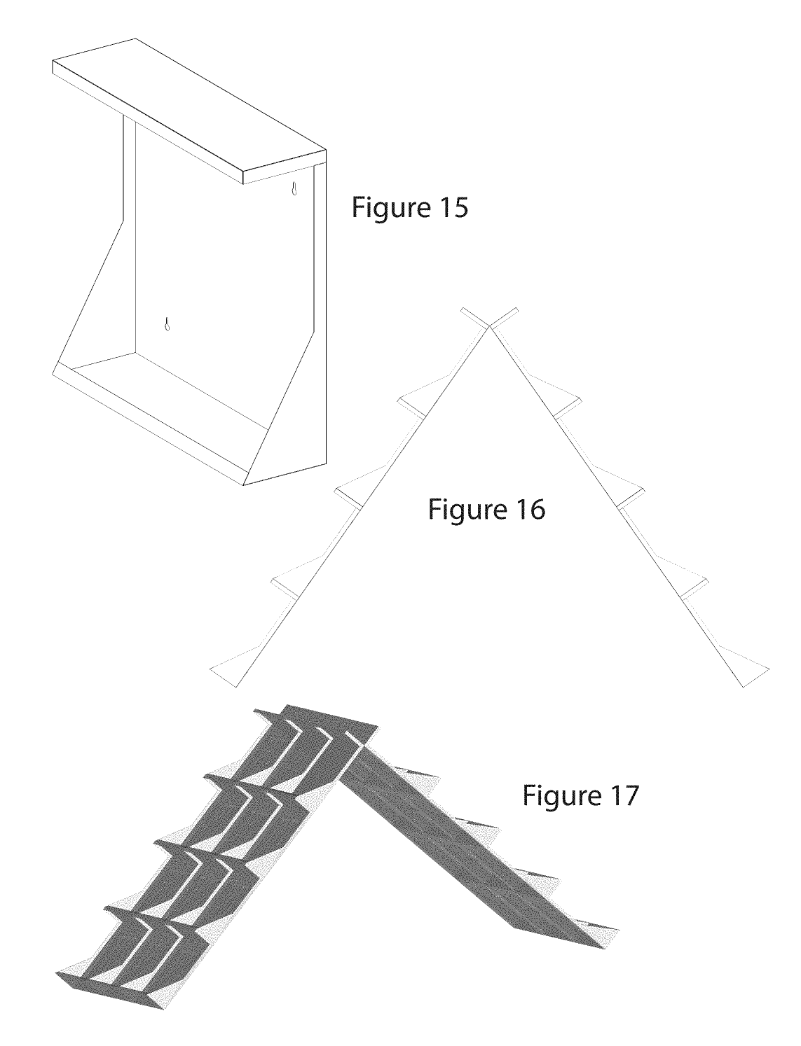

FIG. 15 is a perspective view of an embodiment of an LED lighting rack. FIG. 16 is a side view showing an assembly of LED lighting racks. FIG. 17 is a perspective view of the assembly of LED lighting racks. The rack system shown in the FIGS. 15-17 is particularly suited to use the LED lighting system shown in FIGS. 8-13. Each rack can be easily fabricated from a single cut piece of metal, for example, stainless steel or aluminum, which is cut using a stamping, laser, water jet, plasma, shear or other suitable metal sheet cutting method. Simple bends form the three dimensional structure which can then be welded or fixed in place using, for example, nuts and bolts or sheet metal screws. The single LED lighting rack shown in FIG. 15 can be hung on a wall, with the LED lighting system fixed to the underside of the top shelf. The light radiating from the LED lighting system irradiates plants growing on the grow shelf at the bottom of the rack. When joined together on a frame (not shown), a modular system is constructed as shown in FIGS. 16 and 17. This rack system is particularly suited, for example, for indoor growing in a greenhouse where the growing plants have access to the natural sunlight, and LED lights can be provided to supplement the natural light, extend the growing season, or, in the case of warehouse growing, provide most or all the light used by the growing plant. When assembled as shown in FIGS. 16 and 17, the plant grow area forms a V shaped channel to hold soil and/or liquid growth medium. A drain hole at the bottom of the channel and an input hole provided at the top shelf so that liquid (water, water plus nutrients, liquid growth medium etc.) can trickle down from the top rack the bottom, then collected in a reservoir and pumped up to trickle down again. A bubbler may be included in the reservoir and/or incubator to oxygenate the water or solution contained therein.

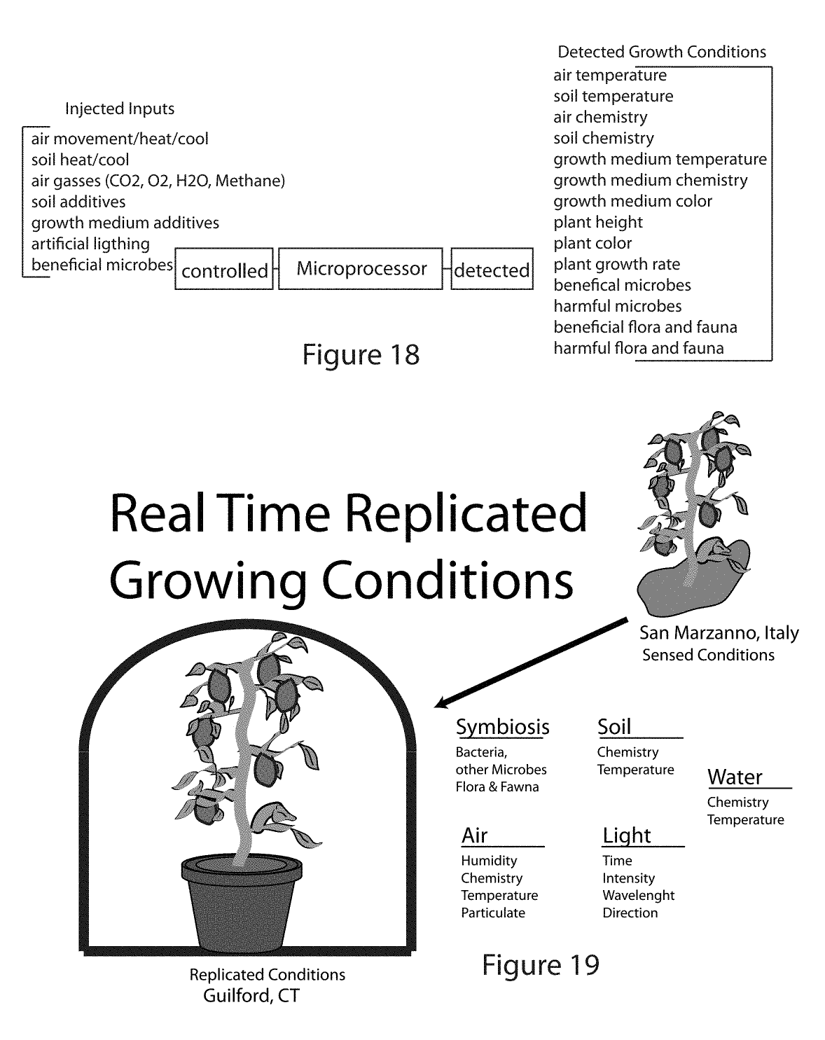

FIG. 18 is a block diagram showing an inventive electronic monitoring and metering system. In accordance with the inventive Accelerated Plant Growth System, the local or ambient growing conditions of the plants can be determined, using an appropriate sensor.

In accordance with the inventive Accelerated Plant Growth System, a microprocessor receives the output of a microclimate detecting system and controls at least one of the lighting system, the beneficial microbe system and the hydroponic system in response to the received output from the microclimate detecting system. The microclimate detecting system detects ambient (e.g., air, water, soil, lighting, microbiology in the soil, water, and/or growth medium) and internal (e.g., microbiology within the plant, light reflecting and transmitting characteristics of the plant's leaves, stalk, buds, flowers, and/or roots) plant growth conditions including at least one of ambient air temperature; soil temperature; air chemistry; soil chemistry; growth medium temperature; growth; medium chemistry; growth medium color; plant height; plant color; plant growth rate; beneficial microbes; harmful microbes; beneficial flora and fauna; harmful flora and fauna; and the like.

Example of pH sensing and adjusting: The following is an example of detecting the pH level of the ambient growing conditions of a plant. This same or similar procedure, system and components can be used for other plant growth related aspects, such as other soil chemistry, water or growth medium chemistry, etc., using appropriate sensors, transducers, detectors that depend on the condition being sensed, the options for making a change to the condition and the grower's desired outcome.

For example, conventional gardeners may have trouble with the pH of the ambient soil, growing medium and/or plants they grow. A high pH can lock out needed nutrients and mimic other problems like Fe and Mg deficiencies. A typical mistake is to try to correct pH problems too quickly. In accordance with the inventive Accelerated Plant Growth System, the ambient growing condition (in this case, the pH level of the growing medium) is determined using, for example, a pH meter. Companies, such as Milwaukee, make f hand-held pH meters. A small “pen” called the Sharp and the larger Smart Meter. A company called Shindengen makes an ISFET pH Meters, which uses a solid state Ion Sensitive Field Effect Transistor (ISFET) instead of the fragile glass electrodes used by traditional pH pens. An example of how a pH sensor can be connected with a microprocessor such as an Arduino microprocessor can be found at parkyswidgets.com/portfolio-item/ph-probe-interface.

The acidity or alkalinity of the soil, plant or growth medium is measured by pH (potential Hydrogen ions). A soil with a pH lower than 7.0 is an acidic soil and one with a pH higher than 7.0 is considered to be alkaline. A pH of 7.0 is neutral. In accordance with the inventive Accelerated Plant Growth System, the ambient or local growing conditions of a plant are sensed. For example, the pH of the soil can be determined using a pH sensor that provides its output to a microprocessor. When the detected pH is beyond a threshold of a target pH, the microprocessor then can provide a warning (buzzer, display, flashing lights) so that the grower knows that the soil needs to have its pH adjusted. Additionally, or alternatively, the proper input (such as bicarbonate of soda) can be automatically added to the the soil (via the water or growing medium) to correct the pH and obtain the optimum pH level for a desired plant growth cycle. In general, it is easier to make a soil more alkaline than it is to make it more acidic. The addition of inputs such as dolomite lime, hardwood ash, bone meal, crushed marble, or crushed oyster shells help to raise the soil pH. These inputs can be finely pulverized and suspended as a liquid concentrate that can be injected as an input. The microprocessor can cause the display, for example, to indicate to the grower that an input is needed. Other inputs, such as potassium silicate, sodium bicarbonate or lime can be added, for example, into the water reservoir in an amount determined by the microprocessor (based on a measured quantity of water in the reservoir and the current determined pH). If, on the other hand, the soil needs to be more acidic, conventionally sawdust, composted leaves, wood chips, cottonseed meal, leaf mold. peat moss, can be added by the grower manually or a concentrated liquid can be injected automatically under the control of the microprocessor to lower the soil pH. Different inputs can be added to the different growing spaces (with separate reservoirs if necessary). For example, bloodmeal or cottonseed meal can be added to the vegetative grow space and bonemeal can be added to the flowering/blooming grow space depending on the separately detected growing conditions in the grow spaces. Nitric acid can be added to the vegetative grow space and phosphoric acid can be added to the flowering/blooming grow space to adjust the pH. Periodically, or in response to a sensed change in the pH, Dolomite lime can be added, since it has a neutral pH of 7. Fine dolomite lime can be added to the soil mix before planting, manually be the grower (with an indication provided by the display) or automatically by the input injecting system under the control of the microprocessor. Dolomite lime can also be high in at least two nutrient inputs such as (Mg) Magnesium and (Ca) Calcium. So, in accordance with the inventive Accelerated Plant Growth System, the pH adjustment made by the addition of an input may cause a change in other sensed ambient growth conditions. Accordingly, since the other ambient growth conditions are sensed along with the pH, a proper balanced growing condition is determined by making the correct adjustments to inputs based on the multiple sensed growth conditions and the desired plant growth characteristics.

While the example of pH sensing and adjustment has been described, it is apparent that this same or similar mechanism, procedure and system can be used to sense and affect the appropriate corrective change to other sensed growth conditions including, but not limited to, the ambient air temperature; soil temperature; air chemistry; soil chemistry; growth medium temperature; growth; medium chemistry; growth medium color; plant height; plant color; plant growth rate; beneficial microbes; harmful microbes; beneficial flora and fauna; harmful flora and fauna; and the like.

FIG. 19 schematically shows a real time replicated growing conditions utilization of the inventive Accelerated Plant Growth System. Aspects of a remote microclimate are measured. For example, the measurement of the remote microclimate may include any factor that determines the growth of a plant to be replicated, including but not limited to the ambient air temperature; soil temperature; air chemistry; soil chemistry; growth medium temperature; growth; medium chemistry; growth medium color; plant height; plant color; plant growth rate; beneficial microbes; harmful microbes; beneficial flora and fauna; harmful flora and fauna; and the like. The measurement is transmitted to a microprocessor, such as, for example, over an internet connection. This remotely taken measurement is used concurrent with a growing plant, and/or stored to be used during a subsequent plant growth cycle, and/or used in the creation of a database where the ambient growth conditions are statistically applied to determine natural and improved controlled growing conditions responding to changes in the natural conditions. At least one aspect of a local microclimate is controlled, where the microclimate is surrounding a growing plant, to replicate at the local microclimate the measured aspect(s) of the remote microclimate.

The microprocessor can receive output from a remote microclimate detecting system and control the inputs added to the air, soil, plants and/or water (growing medium) to replicate at the at least one plant at least one growth condition of the remote microclimate. The microprocessor can receive the output from the remote microclimate detecting system over a network connection. The remote microclimate detecting system can detect the at least one growth condition of the remote microclimate where a same plant type as the at least one plant is growing.

As an exemplary, non-limiting application, San Marzano tomatoes are particularly prized for their firm flesh and taste. San Marzanos, when grown in the Valle del Sarno (valley of the Sarno) in Italy in compliance with Italian law, can be classified as Pomodoro S. Marzano dell'Agro Sarnese-Nocerino and have the EU “DOP” emblem on the label. Although using the seeds from the San Marzano tomatoes grown in Valle del Sarno it is certainly possible to grow the same tomato variety in other parts of the world, there may not be the same overall quality of the harvested tomato. There are many factors, including soil, water and air chemistry, and even the natural sunlight period and wavelengths, climate, water, soil and air quality of the Valle del Sarno. In accordance with this aspect of the invention, the growing conditions at Valle del Sarno can be sensed and duplicated in the controlled ambient environment of the inventive system.

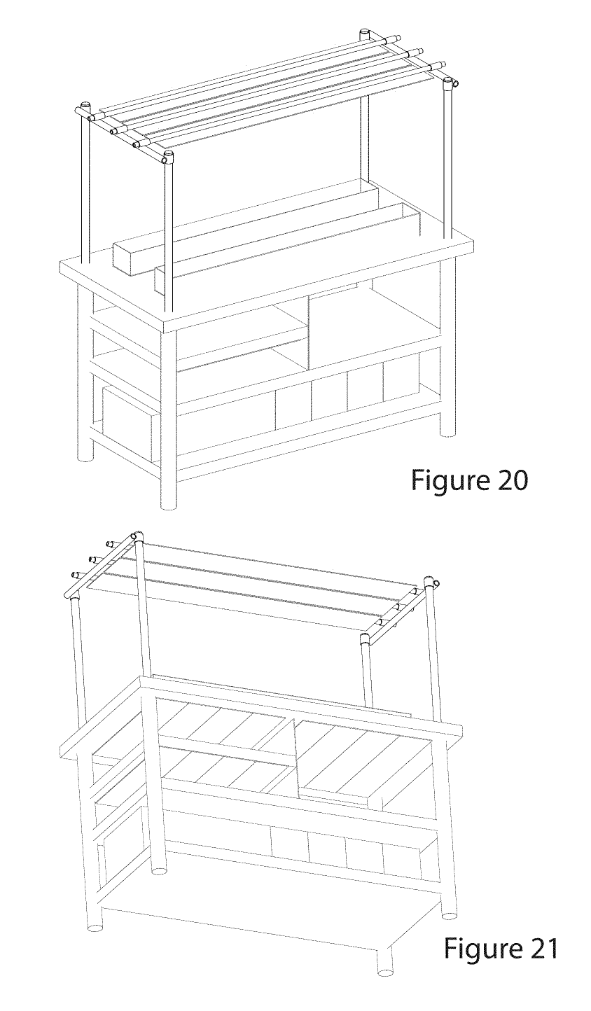

FIG. 20 is a perspective view showing a configuration of the inventive Accelerated Plant Growth System showing three separate growing spaces. FIG. 21 is a bottom perspective view showing the configuration show in FIG. 20 showing individually controllable LED lighting systems associated with each separate growing spaces. In accordance with the inventive Accelerated Plant Growth System, two or more grow areas are provided to enable the continuous and simultaneous growing of multiple plant types (e.g., herbs such as parsley, leafy green vegetables such as lettuce, and fruiting vegetables such as tomatoes) and/or the continuous cycling of the same plant (such as tomatoes) with growth spaces dedicated to, for example, vegetative growth and fruit production. The growth conditions are controlled, and the appropriate input sources are provided, depending on the type of plant or growth cycle of the plant. For example, typically, vegetative growth for certain plants may benefits from a wavelength, intensity, duration cycle for maximum growth, and a different wavelength, intensity, duration cycle for maximum fruit production. Also, the shape and growth rate of the plant can be adjusted by controlling the growth conditions, such as the inputs of wavelength, intensity, duration cycle for the applied artificial and natural (if present) lighting, and other inputs including air, water, soil and growth medium additions (e.g., fertilizer, microbes, CO2, Oxygen, Nitrogen, etc). Even the ambient gasses can make a difference, for example, the presence of ozone in combination with other growth conditions may affect the growth of the plant. The growth conditions are sensed and adjusted by controlling the inputs in accordance with the inventive Accelerated Plant Growth System.

The different plant grow spaces can be used for the continuous production of a particular plant type, from cloning to harvest, with clones created from cuttings taken from one or more “mother” plant used to maintain strain consistency. For example, with every batch of cuttings a few of the cuttings are likely to show superior characteristics, being sturdier and generally looking better. To create a mother plant(s), one or more of these cuttings can be used to create new mother plants. The mother plants can then be used to take cuttings multiple times a year for a number of years.

In accordance with the inventive Accelerated Plant Growth System, the grow area may comprise at least a first grow space and a second grow space. At least one of the growing conditions of the first grow space are set up and/or maintained by the microprocessor to be different than the growing conditions of the second grow space. For example, the growing conditions maintained at the first grow space may favor longer light duration, lower light intensity for vegetative, seedling, clone, pre-flower and/or mother plant growth, and the growing conditions maintained at the second grow space may favor higher light intensity, shorter duration, for flowing, bud and/or fruit growth of the plant. As described herein, the wavelength(s) of light applied at the grow areas may also be different, and at different times (or within subspaces of the grow spaces, the lighting may be applied with different intensity, duration and wavelength(s)).

Depending on the type of plants grown, and the desired production, the grow area may comprise, for example, a seedling grow space configured and dimensioned for growing a number of early stage plants, a vegetative grow space configured and dimensioned for growing a smaller number of vegetative stage plants than the number of early stage plants, and a blooming stage grow space configured and dimensioned for growing a smaller number of blooming stage plants than the number of vegetative stage plants. This configuration is particularly suited to grow a single type of plant with each stage of plant growth, from seedling or clone through vegetative to a periodically haverstable output.

The grow spaces can have separately controlled and applied growth determining inputs and the separately controlled growth determining inputs are automatically controlled by a microprocessor depending on at least one sensed grow condition.

For example, the growing conditions maintained at the first grow space can favor vegetative, seedling, clone, pre-flower and/or mother plant growth of the plant and the growing conditions maintained at the second grow space favor pre-harvest flowing, bud and/or fruit growth of the plant.

The inventive Accelerated Plant Growth System can be used with a wide range of growing techniques and inputs. As an example of a suitable soil mixture, pearlite and potting soil in equal amounts can be used, and additional nutrients and other inputs (such as beneficial microbes) can be added. Other well known inputs, such as B1 root stimulant and 3/10/3 formula can be used, for example, for seedlings located in the grow space. The growing conditions can be sensed, such as by using a moisture meter for sensing soil moisture. As an example, for seedlings it is typically desirable for the soil to be moist but not saturated. The lighting conditions at each grow space are automatically controlled by the microprocessor. For example, to germinate a seed, one can make a hole in the center of soil mixture held in a relatively small seedling pot, place a seed(s) in each hole, cover with soil, and place in an 80 F degree dark area (which could be one of the grow areas partitioned off from light or a separate dark area). The lighting and temperature of the grow space are controlled to maintain the desired growth conditions, and the ambient growth conditions are sampled (periodically or continuously) and logged. The logged data can then be uploaded via a network connection and compiled on a server so that the data automatically collected from a number of grow spaces, and the grow results, can be shared among users and used to advance the collective knowledge of how the growth conditions can be tweaked (automatically via microprocessor control of the inputs applied to the air, soil, water, etc) and/or through intervention by the growers.

Returning to the example of germinating a seed, once the seed germinates, it is moved to the pre-flower grow space and given, for example, 18 hours of light per 24 hour day cycle. As an example, the LED lighting system described herein can provide the desired light input. Alternatively, for example, 40 watt fluorescent grow tubes can be used to provide the relatively low intensity of grow light needed by the seedling in the pre-flower grow space.

After about two weeks, the seedlings are ready to be transplanted to larger containers. In accordance with one exemplary growing method, the gender of the seedlings can be determined to provide mother plants that are used to generate clones. After transplanting, the seedlings are place back into the 18 hour a day light in the pre-flower grow space for another two weeks. After two weeks plants will be ready to have their gender determined.

After transplanting, the plant should be monitored to make sure it remains healthy as the transplantation progresses. As an example of a sense growth condition, a light sensor or camera senses the light reflected from the leaves of the plants growing in the grow spaces. The output of the light sensor or camera is received by the microprocessor and the health and growth characteristics of the plant are determined by comparing the output with, for example, a lookup table or logged data. As an example, if microprocessor determines based on the output received over time from the light sensor or camera that the leaves of the plants in the grow space have a color below a predetermined threshold (for example, the leaves become lighter in color from a desired dark green color), the the microprocessor controls the inputs applied to adjust the growing conditions so that, for example, a vegetative fertilizer is added to the soil of the plants that are detected as having leaves that changed over time to the lighter color.

Continuing the exemplary growth scenario, the gender of each clone is determined so that the female plants can be selected so that, in this scenario, mother plants can be obtained. However, rather than force or wait for the seedling itself to show gender, to determine the gender, a clone can taken of each seedling, and the clones placed in a reduced light environment (without removing the seedlings from the pre-flower grow space). The seedlings continue to grow under optimum lighting of 18 hours per day, and the clones of the seedlings are forced to reveal gender. The clones in the reduced light environment are forced to reveal gender, so that it is determined if the seedling should be kept (female) or removed (male),

A method of creating a clone includes cutting a parent seedling about 4″ from the top and then trimming the lower leaves to create about 3″ stem. The cut clone is then dipped into a rooting liquid, then place into soil with tip of clone submerged into standing water at the bottom of a commercially available plant tray. Each clone/parent seedling pair are identified, for example, by tagging with the same number or letter.

The clones are then put into a suitable container, such as a small peat moss square, and commercially available B1 transplanting fertilizer may be added. With clones, extra water should be added until there is about 1″ standing water at the bottom of the plant tray since the cut tip of the clone has to be in standing water for about a week (changed each day to oxygenate, or an oxygenated bubbler can be included in the reservoir that provides water to the clone plant tray).

Meanwhile, the parent seedlings continue to get 18 hours of light per day. while the clones get 12 hours of light. Using the LED lighting system, the wavelength, intensity and duration of the light applied to the clones and to the seedlings can be easily controlled automatically by the microprocessor and/or manually by the grower. A separate clone gender grow area may be provided, or the clones being gender forced can be placed in the flowing grow area.

Since the plants are photoperiodic, reducing the light applied to the clones to 12 hours per day forces the clones to generate fruit because the reduced lighting replicates the natural light available from the sun during the fall, which forces the gender of the clones to be developed. For example, some plants will show small balls on stalks that indicates the clone is a male, while pods with pistils indicates that the clone is a female. In this exemplary growth scenario, the best female clones are retained and placed in the pre-flower grow space and kept for as long as they remain healthy can capable of being the source of stock for clones that are grown in the inventive Accelerated Plant Growth System. These mother plants are kept in vegetative state under 18 hours of light and, depending on the plant, can be cloned for example, once every two weeks.

In accordance with a non-limiting embodiment of the inventive Accelerated Plant Growth System, separate grow spaces share a common support structure, such as a grow table, and a number of other shared growing resources including, but not limited to a liquid dispensing system (injecting system), including a reservoir, pump, input source (for adding, inputs such as fertilizer, beneficial microbes, minerals, growth medium, etc.), sensors, lighting systems and other components. Depending on the configurations, one or more of the growing resources may be separately controlled or duplicated and separately available for one or more of the grow spaces. For example, a vegetative grow space and seedling grow space can include a shared LED lighting system while a flowering/blooming grow space has a separately controlled HID light source where the light radiating from the LED lighting system is only radiated towards plants in the vegetive grow space and the seedling grow space and light radiating from the HID light source is only radiated on plants in the blooming grow space. Similar to the lighting sources, other resources, such as inputs and sensors may be shared or separated among the grow spaces depending on the configuration.

In accordance with this aspect of the invention, the grow area comprises at least a first grow space and a second grow space. At least one of the growing conditions of the first grow space are maintained by the microprocessor to be different than the growing conditions of the second grow space. The growing conditions maintained at the first grow space can favor vegetative, seedling, clone, pre-flower and/or mother plant growth of the plant and the growing conditions maintained at the second grow space favor flowing, bud and/or fruit growth of the plant.

### Seedling Grow Space:

As illustrated in the FIGS. 20 and 21, the grow space for seedlings and early stage clones can be configured so that a relatively larger number of plants fit within the space, with the height of the light sources above the growing plants fixed or adjustable. Since the plants will undergo relatively less height growth while in the seedling growth space (as compared to the height growth that occurs at the other grow spaces), a doubled up tray space as shown can be accommodated with space efficiency since the doubled up tray space works well with the single tray space provided for the vegetative grow space.

Vegetative Grow Space: As an example, in the case of cloning, after about two weeks, the new clones develop roots and become preflowers. Clones, seedlings, pre-flowers and mother plants are kept at 18 hours a day in the vegetative grow space. The plants in the grow space need to have more room during the vegetative growth period as compared to the smaller plants grown in the seedling grow space.

Blooming Grow Space: The conditions in the blooming grow space are maintained so that the plants are given adequate photo energy (wavelength, intensity and duration) to promote flowing, bud and/or fruit production. However, since it may not be cost effective to provide these lighting conditions with LED lights alone, Low Pressure Sodium lighting, for example, can be used as an alternative or in addition to the LED lightings. Typically, in the blooming grow space, the plants will be given reduced light of about 12 hour per day to stimulate flower, bud and/or fruit production. Typically, the plants will spend 8 weeks in blooming area—depending on the type of plant or plant strain. In the case of the continuous period harvest, although the plants are all the same type, the plants in the different grow spaces are at different stages of growth. So, for example, when plants are placed in blooming area, they will typically be fertilize with less nitrogen and more phosphorous and potassium (for example, 6/30/30 fertilizer). The correct growth conditions for each stage can be obtained by sensing the growth conditions within the space/plants and making the proper adjustments to the inputs applied to the plants within that space.

In accordance with this exemplary grow scenario, the inventive Accelerated Plant Grow System combines aspects of hydroponics, plant nutrients and artificial lighting in a unique method and self-contained apparatus that enables sensing plant growth conditions and automatically controlling the injection of inputs to modify or adjust the sensed plant growth conditions. Using this exemplary grow scenario, each stage of the plant growth takes about two weeks, so every two weeks the grower has to adjust the location of at least some of the plants growing (for example, from the seedling grow space to the vegetative grow space, and from the vegetative grow space to the blooming grow space. Under this scenario, every two weeks plants in the blooming grow space are ready to harvest, making room for the other stages to progress along.

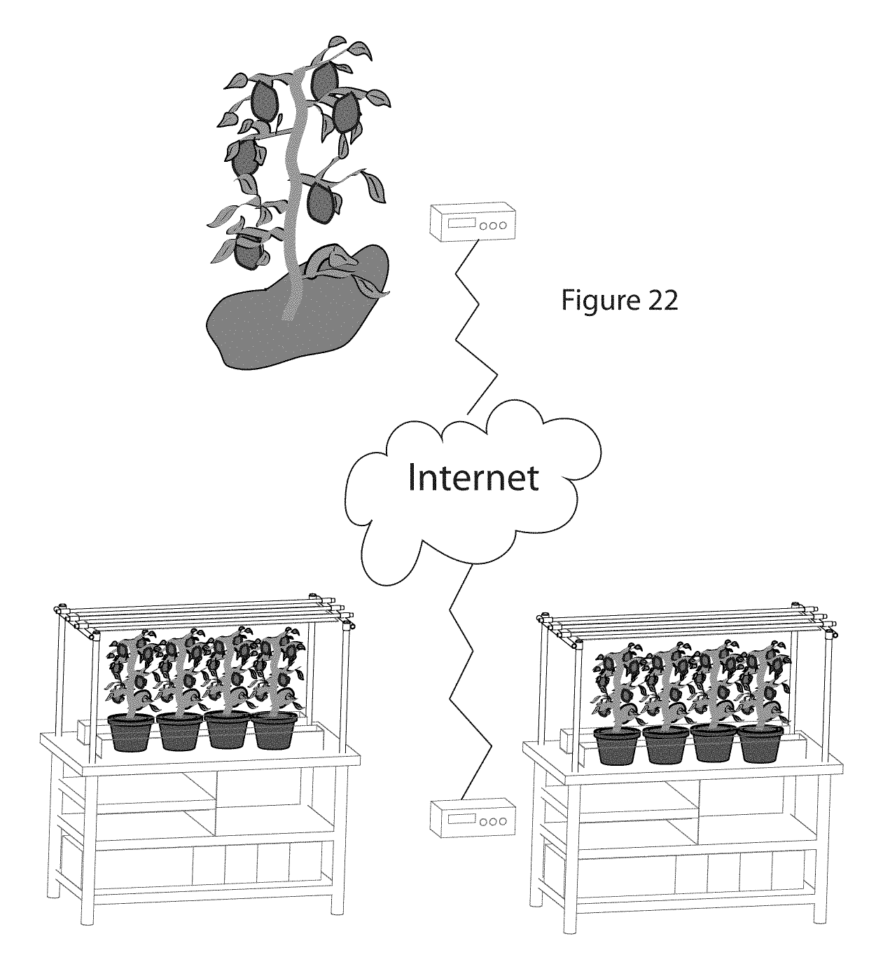

FIG. 22 illustrates a system for collecting growth condition data over a network connection (e.g., WAN and Internet). In accordance with an aspect of the inventive Accelerated Plant Growth System, the microprocessor can be connected through a network connection to one or more grow system units, each unit providing wirelessly or through a wired connection, the sensed growth conditions and/or the receiving control signals for controlling at least one of the lighting system, the beneficial microbe system and the injecting system in response to the received output from the microclimate detecting system.

Using, for example, an internet connection, data from one or more remotely located (relative to each other and/or a data collection server) unit can be collected by a centralized data collection server to enable the use of the collected data to provide improved controlled based on determining what growth conditions work best for a particular plant. In other words, each unit becomes a miniature design of experiments model, with the data (detected growth conditions) automatically collected and the results of inputs (from, for example, the input injecting system) also collected. Sensors, including cameras, photo detectors and even more subjective grower surveys, can be used to determine how each experimental model advances or detracts from a desired grow condition (e.g., harvested fruit, time to harvest, taste, etc). This information can then be shared as an update to be stored in a memory of the control system of the remotely located grow system to be used by respective microprocessor to improve the output of the next grow cycle from the grow system unit.

Although most of the components shown in the Figures are shown at relative size and shape, the size, dimensions and orientation of the different elements can vary, for example, the LED lighting element can be dimensioned to be oriented perpendicular to the long axis of the grow table. IR, UV and visible light cameras/photosensors can be used to help sense the growth of the plant (detecting plant height/width and density of the canopy over time) and also detect presence of unwanted and wanted insects. Sensors provide data regarding the ambient, internal and external conditions of the plant and grow area, microprocessor uses sensed data and look up table to suggest course of action (which might depend on grower's intended outcome for the crop, for example, slow or speed growth, bushy or tall plants, seeds or no seeds,), adjustment of inputs can be automatic (microprocessor controls, for example, the input of soda ash to adjust PH).

1. An accelerated plant growth system, comprising: a first grow area for growing a plurality of plants;
a first lighting system for generating at least one light spectrum received by at least one plant in the first grow area;
a beneficial microbe system for providing beneficial microbes to the at least one plant;
an input injecting system for injecting inputs for adjusting or modifying growing conditions of the at least one plant in the first grow area;
a solution reservoir and transport system for holding and transporting a growth solution to the at least one plant in the first grow area;
a microclimate detecting system for detecting at least one parameter of a microclimate surrounding the at least one plant in the first grow area;
a microprocessor for receiving the output of the microclimate detecting system and controlling at least one of the lighting system, the beneficial microbe system, the input injecting system, and the solution reservoir and transport system in response to the received output from the microclimate detecting system to adjust or modify the growing conditions of the at least one plant in the first grow area.

2. An accelerated plant growth system according to claim 1, wherein microprocessor automatically controls the light spectrum generated by the lighting system depending on at least one of the type of plant and growth cycle of the plant.

3. An accelerated plant growth system according to claim 1, wherein the beneficial microbe system includes a microbe-supporting lighting system for generating a micro-supporting light spectrum specific for the microbes.

4. An accelerated plant growth system according to claim 3, wherein the beneficial microbe system includes a microbe incubator and the microbe-supporting lighting system is disposed for radiating microbes growing in a liquid contained the microbe incubator.

5. The accelerated plant growth system according to claim 1, wherein the microprocessor receives output dependent on at least one remote growth condition of a remote microclimate from a remote microclimate detecting system and controls at least one of the lighting system, input injecting system, the beneficial microbe system, and the solution reservoir and transport system in response to the received input from the remote microclimate detecting system to replicate at the at least one plant at least one growth condition of the remote microclimate.

6. The accelerated plant growth system according to claim 5, wherein the microprocessor receives the output from the remote microclimate detecting system over a network connection.

7. The accelerated plant growth system according to claim 5, wherein the remote microclimate detecting system detects the at least one remote growth condition of the remote microclimate experienced by a same plant type as the at least one plant.

8. The accelerated plant growth system according to claim 1, further comprising a second grow space for growing another plurality of plants;
a second lighting system for generating at least another light spectrum received by at least one other plant in the second grow area;
wherein the beneficial microbe system provides beneficial microbes to the at least one other plant;
wherein the input injecting system adjusts or modifies the growing conditions of the at least one other plant in the second grow area;
wherein the solution reservoir and transport system holds and transports the growth solution to the at least one other plant in the second grow area;
wherein the microclimate detecting system detects at least one parameter of another microclimate surrounding the at least one other plant in the second grow area;
and wherein the microprocessor receives the output of the microclimate detecting system and controls at least one of the second lighting system, the beneficial microbe system, the input injecting system, and the solution reservoir and transport system in response to the received output from the microclimate detecting system to adjust or modify the growing conditions of the at least one plant in the first grow area so that at least one of the growing conditions of the first grow space are maintained by the microprocessor to be different than the growing conditions of the second grow space.

9. The accelerated plant growth system according to claim 8, wherein at least one of the beneficial microbe system, the input injecting system, the solution reservoir and transport system and the microclimate detecting system comprises a separate system for obtaining separately controllable growth conditions wherein the growing conditions of the first grow space are different than the growing conditions of the second grow space.

10. The accelerated plant growth system according to claim 8, wherein the growing conditions maintained at the first grow space favor vegetative, seedling, clone, pre-flower and/or mother plant growth of the plant and the growing conditions maintained at the second grow space favor flowing, bud and/or fruit growth of the plant.

11. The accelerated plant growth system according to claim 1, wherein the microclimate detecting system detects at least one of ambient air temperature; soil temperature; air chemistry; soil chemistry; growth medium temperature; growth; medium chemistry; growth medium color; plant height; plant color; plant growth rate; beneficial microbes; harmful microbes; beneficial flora and/or fauna; and harmful flora and/or fauna.

12. A method of growing a plant, comprising:
measuring at least one grow condition of a microclimate surrounding a growing plant;
adjusting at least one of a lighting spectrum, lighting intensity, air temperature, soil temperature, beneficial microbe, soil chemistry, air moisture, soil moisture, air chemistry, air particulate, and soil particulate dependent on the measured grow condition.

13. A method of growing a plant, comprising:
measuring at least one aspect of a remote microclimate;
transmitting the measurement to a microprocessor over a network connection;
controlling at least one aspect of a local microclimate surrounding a growing plant to replicate at the local microclimate the measured aspect of the remote microclimate.
